(19) United States
(12) Patent Application Publication
(10) Pub. No.: US 2014/0131300 A1
(43) Pub. Date: May 15, 2014

(54) JIB FOR A CRANE

(71) Applicant: Gru Comedil S.r.l., Fontanafredda (PN) (IT)

(72) Inventors: Corrado Scampini, Oleggio (IT); Denis TEDESCO, Cinto (IT); Klaus MEISSNER, Zweibrucken (DE)

(21) Appl. No.: 14/077,651

(22) Filed: Nov. 12, 2013

Related U.S. Application Data
(60) Provisional application No. 61/724,395, filed on Nov. 9, 2012.

(51) Int. Cl. B66C 23/68

(52) U.S. Cl. CPC B66C 23/68
USPC 212/300

(57) ABSTRACT

A jib for a crane is foldable between an operation arrangement and a transportation arrangement. In the operation arrangement a first jib element and a second jib element are coaxially arranged with respect to a longitudinal axis of the unfolded jib. In the transportation arrangement the jib is folded such that the first jib element axis and the second jib element axis are arranged parallel and spaced apart with respect to each other. A first hinge axis of a jib connecting unit and a second hinge axis of the jib connecting unit are oriented transversally with respect to a first jib connecting axis and to a second jib connecting axis, respectively.

### FIELD

The invention is directed on a jib for a crane, in particular for a self-erecting crane, and such a crane, in particular such a self-erecting crane, comprising said jib.

### BACKGROUND

EP 0 870 726 B1 discloses a self-erecting crane with a sideways foldable jib in a transport position of the crane. A jib is foldable and comprises an intermediate folding jib element. However, the folding of the jib is limited due to the kinematics of the intermediate folding jib element.

### SUMMARY

It is therefore an object of the invention to provide a jib for a crane, wherein folding the jib is simplified. In particular, it is an object of the invention to simplify the handling of the jib during folding.

This object is achieved according to the invention by a jib for a crane, in particular for a self-erecting crane comprising a first jib element, a second jib element with the second jib element being connected to the first jib element, and a jib connecting unit, connecting the first jib element to the second jib element, the jib connecting unit comprising a first jib connecting element being articulated to the first jib element, a second jib connecting element being articulated to the second jib element, a first hinge element being articulated to the first jib connecting element, at second hinge element being articulated to the second jib connecting element, wherein the jib is configured to be foldable between an operation arrangement and a transportation arrangement, wherein the operation arrangement configures the first jib element and the second jib element to be coaxially arranged in a longitudinal direction of the jib, wherein under the transportation arrangement the jib is folded such that the first jib element axis and the second jib element axis are arranged parallel to another, wherein a first hinge axis is transversally oriented to a first jib connecting axis, and wherein a second hinge axis is transversally oriented to a second jib connecting axis.

According to the invention, it was recognized that a jib connecting unit enables enhanced connection of a first jib element and a second jib element of a jib for a crane. The jib connecting unit enables a transition of the jib between an operation arrangement and transportation arrangement. In the operation arrangement the first jib element and the second jib element are oriented coaxially to a longitudinal axis of the jib. In the transportation arrangement the jib is folded such that the first jib element and the second jib element are arranged next to each other and in particular are arranged parallel beside each other. The arrangement of the first jib element and the second jib element beside each other in the transportation arrangement is enhanced by the jib connecting unit which comprises a first jib connecting element, a second jib connecting element and at least one jib hinge element being articulated at a first hinge axis with the first jib connecting element and the at least one hinge element being articulated at a second hinge axis with the second jib connecting element. Thus, a lateral arrangement of the first and the second jib element is adjustable. The configuration of the folded jib in the transport arrangement comprises an additional degree of freedom. The first hinge axis and the second hinge axis are arranged with respect to each other at a perpendicular offset. The first hinge axis is transversally oriented to a first jib connecting axis at which the first jib connecting element is articulated with the first jib element. In particular, the first hinge axis is perpendicular to the first jib connecting axis. The second jib connecting element is articulated at a second jib connecting axis with the second jib element. The second hinge axis is transversally, in particular perpendicularly, oriented to the second jib connecting axis. The first jib element comprises a first jib element axis. The second jib element comprises a second jib element axis. In the transportation arrangement of the jib the first jib element axis and the second jib element axis are arranged parallel to each other and spaced apart farther.

A jib with a jib connecting unit according to an embodiment in which the first jib connecting element and the second jib connecting element are configured in a trapezoid shape, comprises enhanced stiffness and structural stability of the first jib connecting element and/or of the second jib connecting element. In particular, at least one of the groups of the first jib connecting element and the second jib connecting element is of trapezoid shape. That means that at least one of the elements comprises a cross section in a plane perpendicular to the longitudinal axis having a trapezoid contour. Thus, the connection of the first jib element, which is usually of rectangular cross section, and of the second jib element, which is in particular of rectangular cross section, is enhanced, since the jib connecting unit at least partially comprises also a four-sided cross sectional shape. A transfer of forces from the second jib element through the jib connecting unit to the first jib element is enhanced. In particular pressure forces are directly led through lower booms of the second jib element, the jib connecting unit and the first jib element. In particular, tension forces are led through upper booms of the second jib element, the jib connecting unit and the first jib element. In particular, the jib connecting unit comprises lower booms building a lower boom plane section and upper booms building an upper boom plane section as base and roof of the trapezoid. The transmission of forces between the first jib element and the second jib element provided by the jib connecting unit is enhanced. In particular, the jib connecting element is not of triangular or pyramidal shape with a vertex at the top of the elements as disclosed in EP 0 870 726 B1.

A jib according to one embodiment in which the first jib connecting element comprises a lower first boom configured in a lower first boom plane section, and wherein the first hinge axis intersects the lower first boom plane section, has a jib connecting unit with a first jib connecting element of enhanced stiffness. Since the first hinge axis which provides articulation of the at least one hinge element is provided inside the first jib connecting element, the stability of the first jib connecting element is enhanced. The first hinge axis intersects a lower first boom plane section which is built by two lower first booms of the first jib connecting element. In particular, the two lower first booms extend along the longitudinal axis. The first hinge axis is provided at least partially inside the cross sectional area of the first jib connecting element.

A jib according to one embodiment comprises an upper first boom plane section for enhancing the stiffness of the first jib connecting element. In particular, the upper first boom plane section has at least partially an inclination with respect to a horizontal plane.

A jib according to one embodiment in which the first jib connecting element is connected to the first jib element by a first telescopic cylinder, wherein the first telescopic cylinder is articulated at a first cylinder hinge axis against the first jib connecting element, and wherein the first cylinder hinge axis is configured between the lower first boom plane section and the upper first boom plane section, provides enhanced folding. A telescopic cylinder is provided for connecting the first jib connecting element to the first jib element. The first telescopic cylinder is articulated at the first jib connecting element around a first cylinder hinge axis. The first cylinder hinge axis is arranged between the lower first boom plane section and the upper first boom plane section.

A jib according to an embodiment comprises a second jib connecting element configured similarly to the first jib connecting element. The advantages are the same discussed above to which reference made is, respectively.

A jib according to an embodiment comprises a jib connecting unit with two hinge elements. The two hinge elements are concentrically arranged concerning the first hinge axis and the second hinge axis. Thus, it is possible to provide secure and stable articulation of the first and second jib connecting elements on the one hand and a weight reduction of the hinge elements on the other hand.

A jib according to an embodiment in which the two hinge elements are spaced apart from one another alongside the first hinge axis and the second hinge axis, comprises enhanced accessibility to the jib connecting unit, in particular to the first and to the second jib connecting elements also in the operation arrangement.

A jib according to an embodiment in which two hinge elements are articulated at an intermediate hinge axis, provides further flexibility for the handling of the jib connecting elements of the jib connecting unit. Since an additional, intermediate hinge axis is provided, the two hinge elements can be articulated at the intermediate hinge axis. An additional degree of freedom for kinematics of the hinge elements is provided.

A jib according to an embodiment, in which the two hinge elements are configured displaceable between a connecting arrangement and an offset arrangement, wherein under the connecting arrangement the first jib connecting element and the second jib connecting element are connected to another, and wherein under the offset arrangement the first jib connecting element and the second jib connecting element are spaced apart from another alongside a longitudinal axis by an axial offset, enables an offset of the first jib element and the second jib element along the longitudinal axis such that the first jib element and the second jib element are spaced apart from each other along the longitudinal axis.

A jib according to an embodiment in which an intermediate hinge axis is configured coaxial to a fixing axis, and wherein the first jib connecting element and the second jib connecting element are fixed to another in an operation mode, enables enhanced stiffness of the hinge elements since the intermediate hinge axis is coaxially arranged to a fixing axis of the hinge elements. The fixing axis enables fixing of the first jib connecting element with the second jib connecting element, in particular in the operation arrangement. Thus, the intermediate hinge axis provides multiple functionality.

A jib according to an embodiment in which each of the two hinge elements comprises a blocking bore, wherein under the offset arrangement the blocking bores are aligned coaxial and are connected by a connecting element, and wherein articulation around the intermediate hinge axis is prohibited, enables blocking of the articulation of the two hinge elements to each other around the intermediate hinge axis. For that purpose, each of the two hinge elements comprises a blocking bore, wherein in the offset arrangement of the two hinge elements the blocking bores are aligned concentrically. Thus, it is possible to block articulation of the two hinge elements by connecting the elements with a connecting element, such as a bolt. Then, the articulation around the intermediate hinge axis is prevented.

A jib according to an embodiment in which the first jib connecting element and the second jib connecting element comprises of a fixing element configured to be fixed to another under the operation arrangement of the jib, enhances the handling of the jib, in particular during an operation, i.e. in operation arrangement of the jib.

At least one fixing element is provided at the jib elements of the jib. The fixing element can be realized by bores to be aligned concentrically in the operation arrangement of the jib such that the aligned bores are to be fixed with a bolt. However, other fixing elements can be provided as well. In particular, the fixing elements, in particular the bores to be aligned are arranged spaced apart from the first hinge axis and the second hinge axis. In particular, the bores are aligned concentrically to a fixing axis, wherein the fixing axis oriented parallel to the first hinge axis and the second hinge axis.

It is a further object to of the invention to provide a crane, in particular a self-erecting crane, that provides simplified erecting of the crane on the one hand and easy transport of the crane in a transport arrangement on the other hand.

This object is achieved according to the invention by a crane, in particular by a self-erecting crane, comprising comprising of a basic structure, a mast comprising a mast longitudinal axis, wherein the mast is connected to the basic structure, a jib according to an embodiment of the invention, wherein the jib is foldable between an operation arrangement and a transportation configuration, wherein under the operation arrangement a first jib element and a second jib element are configured coaxial to a longitudinal axis, and wherein under the transportation arrangement one of the first and second jib elements is configured such that the longitudinal axis and a first jib element axis and a second jib element axis make corner a triangle.

According to the invention, it was recognized that a crane having a jib according to the disclosed and claimed subject matter, enables folding the jib between the operational arrangement and the transportation arrangement. In the transportation arrangement, at least one of the jib elements is arranged such that a mast axis, the first jib element axis and the second jib element axis are arranged at corners of a triangle. In particular, the mast, the first jib element and the second jib element each comprise a rectangular cross section concerning their longitudinal axis, wherein in the transportation arrangement the mast is arranged neighboring to a horizontal edge of the rectangular cross section of the first jib element and the second jib element is arranged neighboring to a vertical edge of the rectangular cross section of the first jib element. The mast and the second jib element are arranged at neighboring edges of the rectangular cross section of the first jib element. In particular, the mast, the first jib element and the second jib element are not arranged in a stack formation stacked on each other in one direction. Thus, the crane according to this embodiment comprises an enhanced transportation arrangement. In particular it possible to transport the crane on regular streets, since the crane in the transportation arrangement does not exceed height limitations. Also transport by train or ship is possible.

It is a further aspect of the invention to provide a self-erecting crane with a foldable jib such that folding the jib between a transportation arrangement and an operation arrangement is enhanced.

This object is achieved according to the invention by a self-erecting crane with a foldable jib comprising a first jib element, a second jib element and a third jib element, a jib connecting unit connecting the first jib element to the second jib element, wherein the second jib element and the third jib element of the foldable jib are configured alongside a mast of the self-erecting crane under a transportation position, wherein the jib connecting unit further comprises a) a first jib connecting element having a rectangular base, wherein the first jib connecting element is connected to the first jib element in the area of lower booms at a transverse first jib connecting axis and wherein the first jib connecting element is connected to the first jib element via a first telescopic cylinder to upper booms of the first jib element, b) a second jib connecting element having a rectangular base, wherein the second jib connecting element is connected to the second jib element in the area of lower booms at a transverse second jib connecting axis and wherein the second jib connecting element is connected to the second jib element via a second telescopic cylinder to upper booms of the second jib element, c) a hinge element joining the first jib connecting element to the second jib connecting element, wherein the hinge element determines at least one vertical hinge axis, and d) non-permanent fixing elements for interlocking the jib connecting element with the second jib connecting element in an operation position of the crane, wherein the at least one hinge axis is situated at least partially inside the jib connecting unit.

According to the invention, it was recognized that the folding of a jib of a self-erecting crane is enhanced having a jib connecting unit comprising a first and a second jib connecting element which are articulated to each other at at least one vertical hinge axis. The at least one hinge axis is situated at least partially inside of the jib connecting unit. In particular, the hinge axis intersects a lower boom plane section of the first jib connecting element or of the second jib connecting element. The lower boom plane sections of the corresponding jib connecting elements in particular build a rectangular base having lower booms. In particular, the hinge axis intersects at least one of the lower booms. Thus, the hinge axis is not situated on one of the sides of the jib connecting unit. It is possible that the at least one hinge axis is situated completely inside the jib connecting unit. In particular, the hinge axis intersects the rectangular base and a rectangular roof built by an upper boom plane section. Since the hinge axis is integrated in the jib connecting unit, the stiffness of the jib connecting unit is enhanced. Further, flexibility concerning the articulation of the jib connecting elements to each other is not affected. The jib connecting unit enables stable, secure and flexible folding of the jib.

The current invention comprises the self-erecting crane of the disclosed embodiments also in combination with at least one of the further features described in this application.

Embodiments of the invention will be described in more detail below by the drawings.

### BRIEF DESCRIPTION OF THE DRAWINGS

FIG. 1 shows a side view of a self-erected crane in an operation arrangement

FIG. 2 is an isometric view of the crane in FIG. 1 in a transportation arrangement,

FIG. 3 is a front view of the crane in FIG. 2,

FIG. 4 is a side view of a jib connecting unit according to a first embodiment of the invention.

FIG. 5 is an isometric view of the jib connecting unit in FIG. 4,

FIG. 6 is a top view of a jib connecting unit in FIG. 4,

FIG. 7 is a top view corresponding to FIG. 6 with the jib connecting unit in a transformation position,

FIG. 8 is a top view corresponding to FIG. 6, 7 in a further transformation position,

FIG. 9 is a top view corresponding to FIGS. 6 to 8 in a transportation arrangement of the jib connecting unit,

FIG. 10 is a side view of a jib connecting unit according to a further embodiment of the invention,

FIG. 11 is a top view of the jib connecting unit in FIG. 10 in the operation arrangement,

FIG. 12 is a top view of the jib connecting unit corresponding to FIG. 11 in a transformation position,

FIG. 13 is a top view of the jib connecting unit corresponding to FIG. 11, 12 in another transformation position,

FIG. 14 is a top view of the jib connecting unit corresponding to FIGS. 11 to 13 in another transformation position,

FIG. 15 is a top view of the jib connecting unit corresponding to FIGS. 11 to 14 in the transportation arrangement,

FIG. 16 is a side view of a jib connecting unit according to a further embodiment of the invention,

FIG. 17 is a top view of the jib connecting unit in FIG. 16 in an operation arrangement,

FIG. 18 is an isometric view of the jib connecting unit in FIG. 16,

FIG. 19 is a top view of the jib connecting unit corresponding to FIG. 17 in a transformation position,

FIG. 20 is a top view of the jib connecting unit corresponding to FIGS. 17 and 19 in a transportation arrangement,

FIG. 21 is a side view a jib connecting unit according to a further embodiment of the invention,

FIG. 22 is a top view of the jib connecting unit in FIG. 21 in an operation arrangement,

FIG. 23 is an isometric view of the jib connecting unit in FIG. 21,

FIG. 24 is a top view of the jib connecting unit corresponding to FIG. 22 in an offset arrangement,

FIG. 25 is a top view of the jib connecting unit corresponding to FIGS. 22 and 24 in a transformation arrangement,

FIG. 26 is a top view of the jib connecting unit corresponding to FIGS. 22, 24 and 25 in another transformation position and

FIG. 27 is a top view of the jib connecting unit corresponding to FIGS. 22 and 24 to 26 in a transportation arrangement.

### GENERAL DESCRIPTION

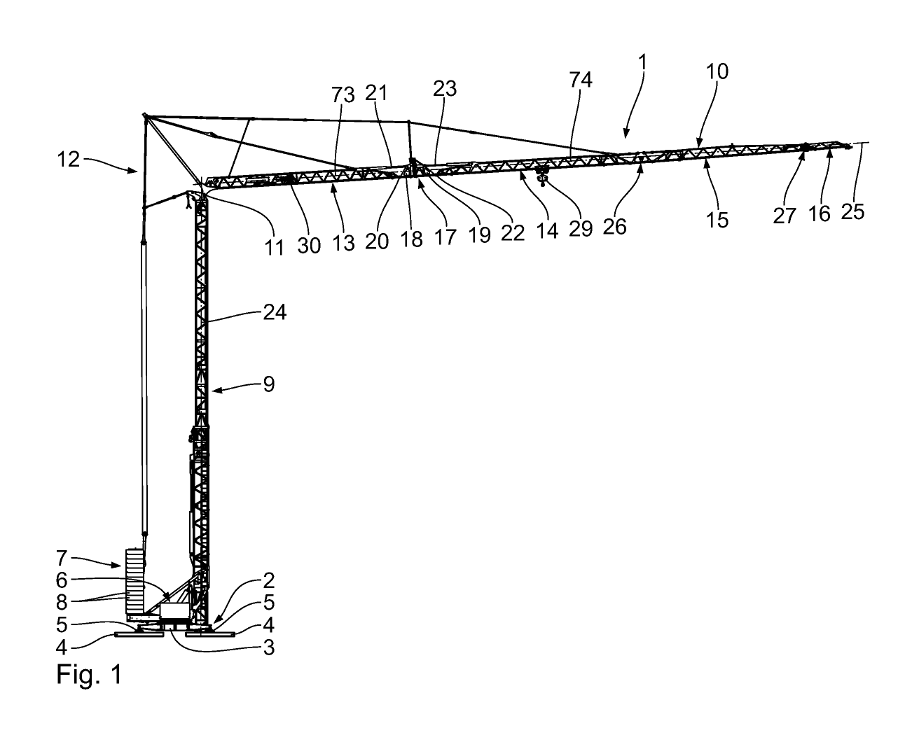

FIG. 1 shows a side view of a self-erected crane 1. The crane 1 comprises a basic structure 2 with an undercarriage 3 which is supported on a ground 4 via struts 5. The basic structure 2 further comprises an upper carriage 6 to which a counter weight arrangement 7 comprising several stackable counter weights 8 is attached. A mast 9 is connected to the upper carriage 6 of the basic structure 2. The mast 9 is oriented vertically with respect to the ground 4. The mast 9 comprises a mast longitudinal axis 24. The mast longitudinal axis 24 is vertically oriented. The mast 9 comprises several lattice sections arranged along the mast longitudinal axis 24. It is possible to provide the mast 9 telescopically, wherein a lower section of the mast comprises a larger cross sectional area than an upper section of the mast such that the upper section can be stacked into the lower section for space-saving arrangement of the mast 9 in a transportation arrangement.

At the tip of the mast 9, a jib 10 is articulated around a horizontal axis 11. The jib 10 is luffable around the horizontal axis 11. Thus, the horizontal axis 11 is also called luffing axis. A corresponding luffing plane is vertically oriented. The luffing plane is the drawing plane of FIG. 1.

The jib 10 is slacked via a slacking device 12 at the counter weight arrangement 7. The jib 10 comprises a first jib element 13, a second jib element 14, a third jib element 15 and a fourth jib element 16. The first jib element 13 comprises a first jib element axis 73. The second jib element 14 comprises a second jib element axis 74. The first jib element 13 is articulated at the horizontal axis 11 with the mast. The first jib element is also called jib foot element. The first jib element 13 and the second jib element 14 are connected via a connecting unit 17 with a first jib connecting element 18 and a second jib connecting element 19. The jib connecting unit 17 is explained in detail later.

The first jib element 13 is directly articulated at a first jib connecting axis 20 with the first jib connecting element 18. The first jib connecting axis 20 is arranged in the region of lower booms of the first jib element 13. In the region of upper booms of the first jib element 13, it is connected to the first connecting element 18 via a first telescopic cylinder 21.

The second jib element 14 is directly articulated at a second jib connecting axis 22 with the second jib connecting element 19. The second jib connecting axis 22 is horizontally oriented. The second jib connecting axis 22 is arranged in an area next to the lower booms of the second jib element 14. In an area of upper booms of the second jib element 14, the second jib element 14 is connected to the second jib connecting element 19 via a second telescopic cylinder 23.

The jib 10 comprises a longitudinal axis 25. In the arrangement of the crane 1 in FIG. 1, the crane can be operated, in particular for lifting and lowering a load. The arrangement in FIG. 1 is referred to as the operation arrangement of the crane 1. In the operation arrangement of the crane 1, the jib 10 is unfolded, i.e. the first jib element 13, the second jib element 14, the third jib element 15 and the fourth jib element 16 are disposed along the longitudinal axis 25. In the operation arrangement, the first jib element 13 and the second jib element 14 are coaxially arranged with respect to the longitudinal axis 25. The first jib element axis 73 is coincident with the longitudinal axis 25. The second jib element axis 74 is coincident with the longitudinal axis 25. As can be seen from FIG. 1, the longitudinal axis 25 is at an inclination with respect to the horizontal plane of about 5°. It is also possible to arrange the jib 10 in another luffing position, in particular with a luffing angle in a range between 0° to 25°, with respect to the horizontal plane.

For lifting and lowering a load with the crane 1, a travelling trolley 29 is provided. The travelling trolley 29 is provided at lower booms of the jib 10. In particular, the travelling trolley 29 is guided along the lower booms of the jib 10. The travelling trolley 29 is driven by trolley motor 30 via cables.

The second jib element 14 is connected to the third jib element 15 via a first connecting element 26. The third jib element 15 and the fourth jib element 16 are connected with each other via a second connecting element 27. The fourth jib element 16 comprises a cross sectional area such that it can be nested onto the third jib element 15. In particular, the fourth jib element 16 has an essentially U-shaped cross section with an opening of the U at an upper end. When articulating the fourth jib element 16 at the second connecting element 27 counterclockwise in FIG. 1, the fourth jib element 16 can be set on top of the third jib element 15, wherein the lattice elements of the third jib element 15 are disposed inside the open cross section of the fourth jib element 16. Thus, folding of the fourth jib element 16 onto the third jib element 15 does not lead to an enlargement of the height of the jib 10.

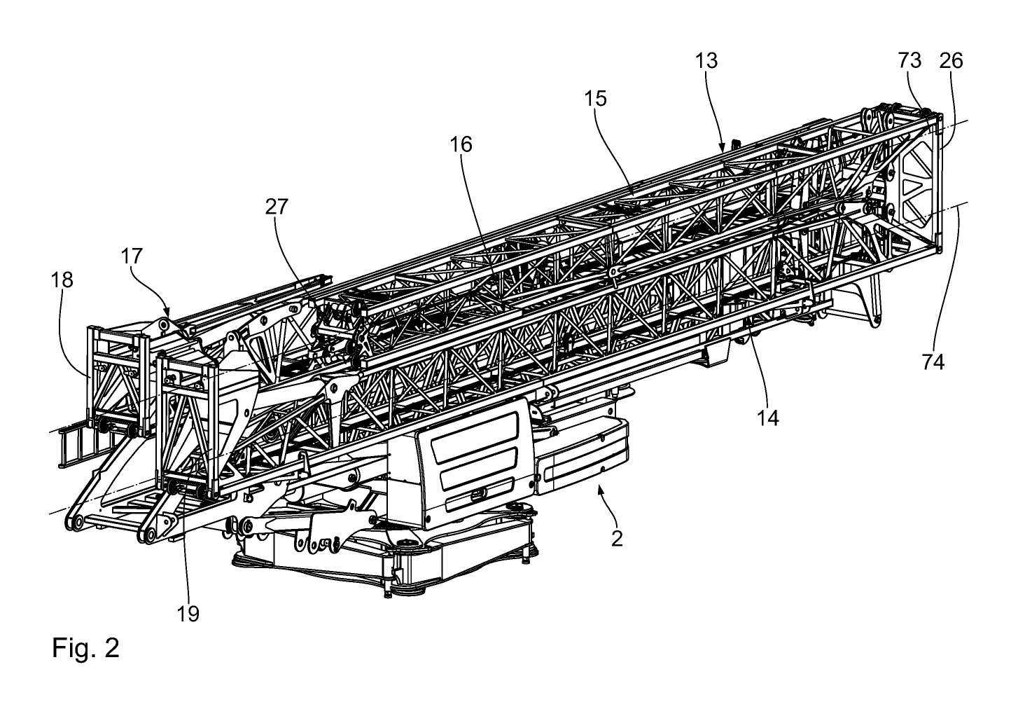

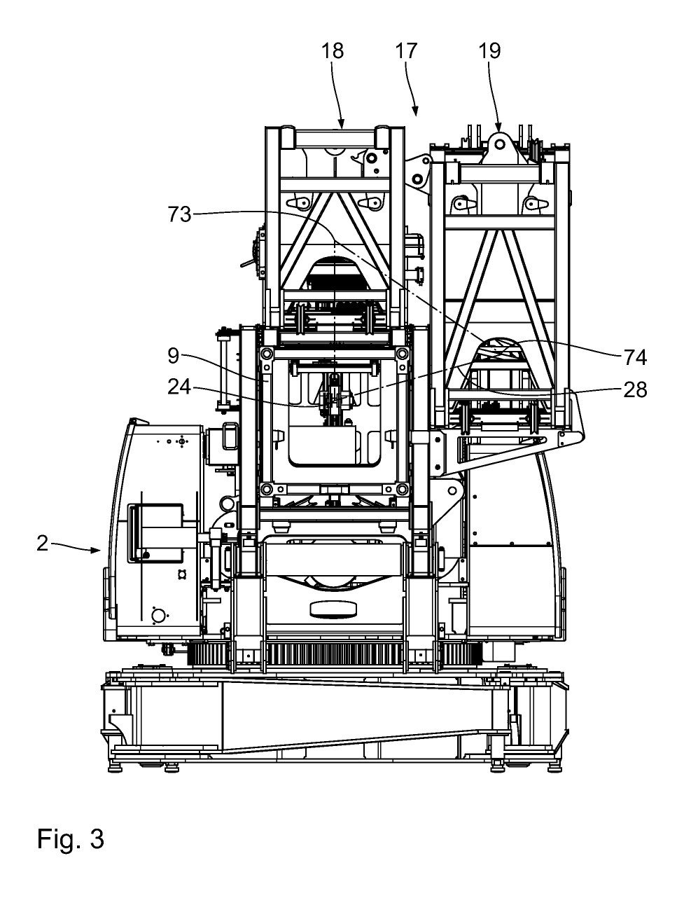

FIGS. 2 and 3 show a folded arrangement of the crane 1 and in particular of the jib 10, is illustrated. The fourth jib element 16 is nested on the third jib element 15 as described above. The third jib element 15 and the fourth jib element 16 are connected via the second connecting element 27. Further, the second jib element 14 is connected via the vertically arranged first connecting element 26 with the third jib element 15. As shown in FIG. 2, the third jib element 15 together with the fourth jib element 16, are arranged on the second jib element 14. Since the third jib element 15 is folded on the second jib element 14 using the first connecting element 26, the fourth jib element 16 is arranged between the second jib element 14 and the third jib element 15. That means that the third jib element 15 is, in the transportation arrangement according to FIG. 2, articulated with 180° around a horizontal axis of the first connecting element 26 and is therefore in a reversed arrangement. The second jib element 14 is connected via the jib connecting unit 17 to the first jib element 13. The first jib element 13 is arranged behind the second jib element 14, third jib element 15 and fourth jib element 16 as illustrated in FIG. 2. That means that the first jib element 13 and the second jib element 14 are not arranged on top of each other but beside each other.

As best seen in FIG. 3, the first jib connecting element 18 and the second jib connecting element 19 are articulated with respect to each other. The first jib element 13 is arranged on top of the mast 9. The mast longitudinal axis 24, the first jib element axis 73 and the second jib element axis 74 are arranged at corners of a triangle 28 which is schematically illustrated in FIG. 3. In particular, the mast 9, first jib element 13 and the second jib element 14 are not stacked on each other such that their corresponding axes 24, 73, 74 are arranged along one direction. Thus, it is possible to dispose the second jib element 14 beside the mast 9 and the first jib element 13. The height of the crane 1 in the transportation arrangement as illustrated in FIGS. 2 and 3 is reduced.

### DETAILED DESCRIPTION

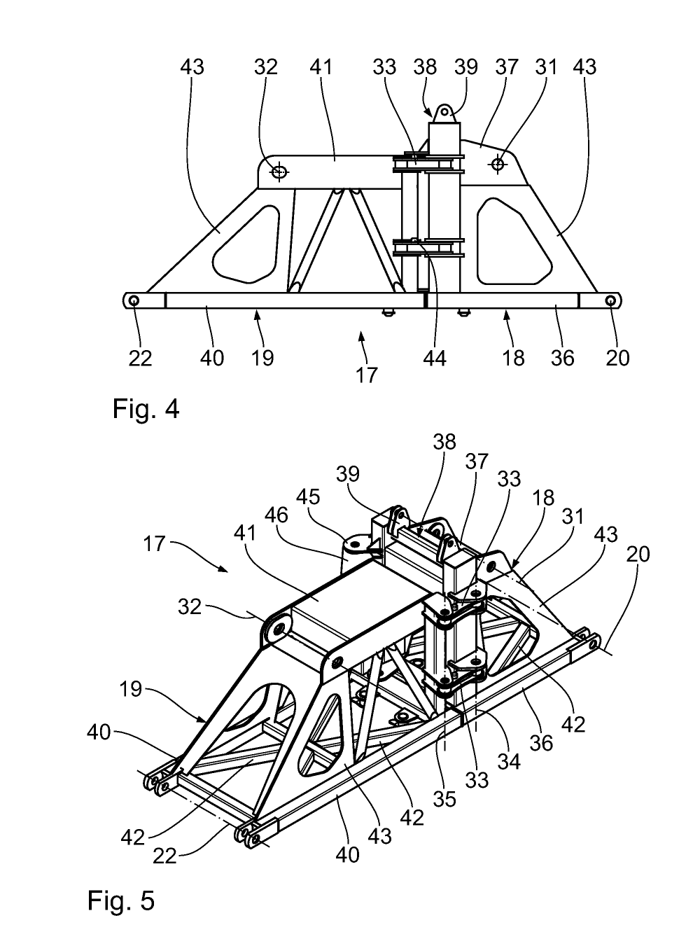

An exemplary embodiment of the jib connecting unit 17 is shown in FIG. 4 to FIG. 9. The jib connecting unit 17 comprises the first jib connecting element 18 and the second jib connecting element 19. The first jib connecting element 18 provides openings arranged concentrically to the first jib connecting axis 20. Additional openings are provided concentrically to a first cylinder hinge axis 31.

The second jib connecting element 19 provides openings concentrically arranged concerning the second jib connecting axis 22. Further openings are provided concentrically around a second cylinder hinge axis 32. The jib connecting axes 20, 22 and the cylinder hinge axes 31, 32 are oriented parallel to each other. In particular, the axes 20, 22, 31 and 32 are horizontally oriented. The axes 20, 22, 31 and 32 are oriented perpendicular to the longitudinal axis 25 of the jib 10.

The first jib connecting element 18 is connected with the second jib connecting element 19 via two hinge elements 33. Each hinge element 33 is provided as a connecting rod articulated at a first hinge axis 34 with the first jib connecting element 18 and articulated at a second hinge axis 35 with the second jib connecting element 19. The first hinge axis 34 and the second hinge axis 35 are arranged with a lateral offset D with respect to each other, wherein the offset D is oriented perpendicular to the first hinge axis 34 and to the second hinge axis 35. In particular, the lateral offset D is oriented parallel to the longitudinal axis 25 of the jib 10.

Both the first jib connecting element 18 and the second jib connecting element 19 each comprise a cross section oriented perpendicular to the longitudinal axis 25, wherein the cross section is of trapezoid shape. The trapezoid comprises a bottom in the form of a lower first boom plane section defined by two lower first booms 36 extending along the longitudinal axis 25. A roof of the trapezoid is provided in the form of an upper first boom plane section. The upper first boom plane section is provided by an upper first plate element 37. The first cylinder hinge axis 31 intersects the upper first plate element 37. The first jib connecting axis 20 intersects each of the lower first booms 36 at free ends facing the first jib element 13. The upper first plate element 37 comprises an inclination concerning a horizontal plane.

At an upper end 38 of the first jib connecting element 18, receiving elements 39 are provided for receiving rope guiding elements, e.g., rope discs, or for receiving structural parts of the jib, e.g. struts.

The second jib connecting element 19 comprises lower second booms 40 defining a lower second boom plane section. Further, an upper second plate element 41 defines an upper second boom plane section. The upper second boom plane section may comprise at least partially an inclination with respect to the horizontal. The trapezoid of the second jib connecting element 19 has a bottom in the form of the lower second boom plane section and a roof in the form of an upper second boom plane section.

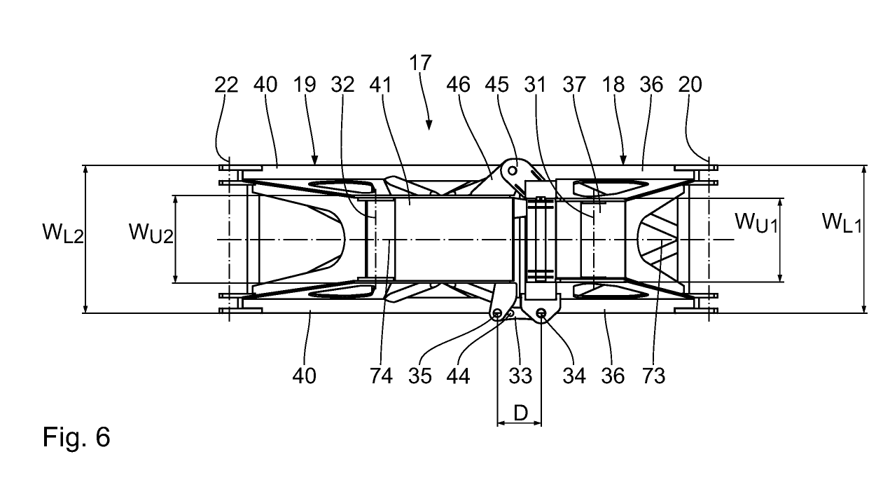

The upper first boom plane section has a width W_{U1}. The lower first boom plane section has a width W_{L1}. The lower second boom plane section has a width W_{L2}. The upper second boom plane section has a width W_{U2}. As best seen from FIG. 6, width W_{U1} of the upper boom plane section of the first jib connecting element 18 is nearly identical to the width W_{U2} of the upper boom plane section of the second jib connecting element 19. Further, the width W_{L1} of the lower boom plane section of the first jib connecting element 18 is nearly identical to the width W_{L2} of the lower boom plane section of the second jib connecting element 19. The widths W_{U1}, W_{U2} of the upper boom plane sections of the jib connecting elements 18, 19, each are narrower than the widths W_{L1}, W_{L2} of each corresponding lower boom plane section.

Each of the lower boom plane sections comprises several stiffening struts 42. The lower first boom plane sections are each connected with the corresponding upper first plate elements 37, 41 with stiffening plates 43. The stiffening plates 43 each comprise a window for reduction of the material amount and therefore for reduction of the weight.

As best seen from FIG. 6, both the first hinge axis 34 and the second hinge axis 35 intersect the corresponding lower boom plane section. According to the embodiment shown, the first hinge axis 34 and the second hinge axis 35 intersect at least the lower booms 36, 40.

Each of the hinge elements 33 comprises a stopping pin 44 in order to provide a defined positioning of the first jib connecting element 18 relative to the second jib connecting element 19.

The hinge elements 33 are concentrically arranged concerning the first hinge axis 34 and the second hinge axis 35. The two hinge elements 33 are spaced apart from each other along the first hinge axis 34 and along the second hinge axis 35.

The first jib connecting element 18 provides a first fixing element 45 and the second jib connecting element 19 comprises a second fixing element 46. Both fixing elements 45, 46 comprise an opening, wherein the openings 45, 46 are aligned with each other in the operation arrangement of the jib connecting unit 17 as illustrated in FIGS. 4 to 6. Thus, the first jib connecting element 18 and the second jib connecting element 19 can be fixed to each other, e.g., by using a bolt in the aligned bores of the fixing elements 45, 46 such that articulation of the first jib connecting element 18 relative to the second jib connecting element 19 along at least one of the hinge axis 34, 35 is prevented.

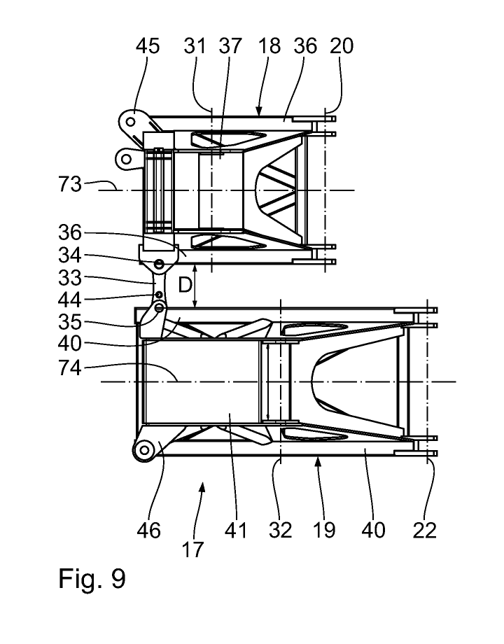

In the following, a transformation of the crane 1 and in particular of the jib connecting unit 17 from the operation arrangement in FIG. 6 to the transportation arrangement in FIG. 9 is described.

To understand the whole self-erecting process of the crane 1, it must be understood that starting from the operation arrangement of the crane 1 with the linear, unfolded arrangement of the jib 10, the jib elements 13 to 17 are disposed coaxially to the longitudinal axis 25. Starting the folding means folding the fourth jib element 16 with the second connecting element 27 onto the third jib element 15. Further, the third jib element 15, together with the folded fourth jib element 16, are folded via the first connecting element 26 onto the second jib element 14. Thus, a labyrinth-like arrangement of the second jib element 14, the third jib element 15 and the fourth jib element 16 results as shown in FIG. 2. Further, the second jib element 14 together with the third jib element 15 and the fourth jib element 16 are articulated around the second connecting axis 22 from a nearly horizontal arrangement in FIG. 1 counterclockwise for approximately 90°. This articulation is provided by the second telescopic cylinder 23. In a similar manner the first telescopic cylinder 21 is used to articulate the first jib element 13 at the first jib connecting axis 20 towards the jib connecting unit 17 clockwise for approximately 90° such that in the folded arrangement of the jib 20, the first jib element 13 and the second jib element 14 are arranged such that the telescopic cylinders 21, 23 are neighboring, i.e., next to, one another. This folding is a first folding step, wherein the first jib element 13 and the second jib element 14 are folded with respect to the jib connecting unit 17. The folding takes place in a vertical plane around the first jib connecting axis 20 and the second jib connecting axis 22.

A second folding step is provided by the jib connecting unit 17 itself. The second folding step provides a folding in a horizontal plane and in particular out of the vertical plane. The jib connecting unit 17 is also called a bi-fold hinge connecting element for a jib boom.

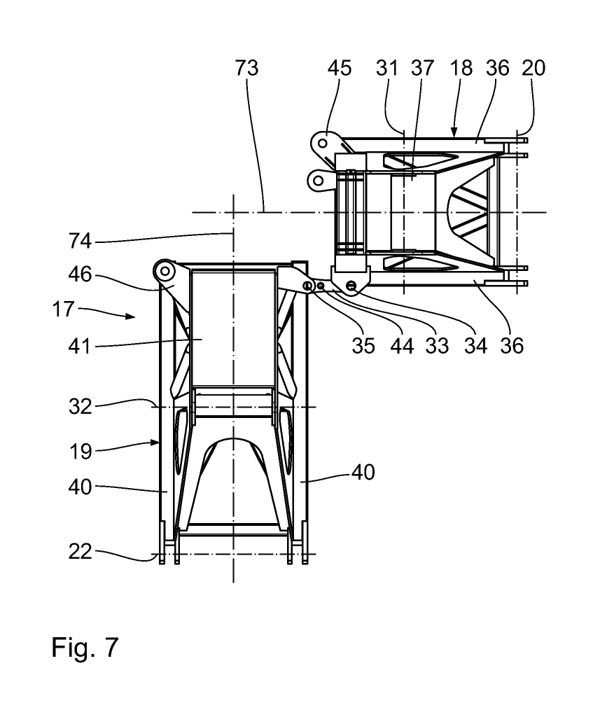

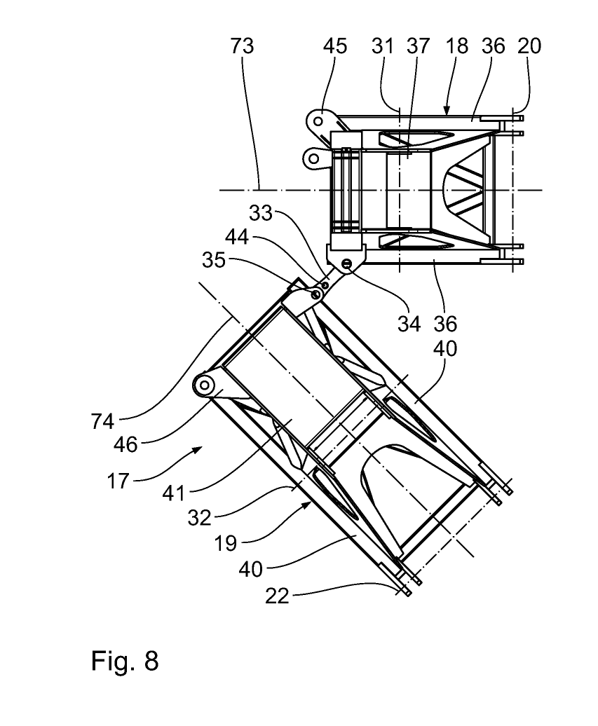

In particular, the second folding step is illustrated in FIGS. 6 to 9. Starting from the fixed arrangement of the jib connecting unit 17 in FIG. 6, the fixation is released by releasing the bolt fixing the fixing elements 45, 46. Thus, it is possible to articulate the second jib connecting element 19 at the second hinge axis 35. A 90° rotational transformation position is given in FIG. 7. Then, the second jib connecting element 19 together with the two hinge elements 33 are rotated around the first hinge axis 34 in a counterclockwise direction according to FIG. 8. A final position of the second jib connecting element 19 is illustrated in FIG. 9, wherein the first jib connecting element 18 and the second jib connecting element 19 are arranged next to each other and parallel to each other. Since the hinge elements 33 are essentially oriented perpendicular to each longitudinal axis of the first jib connecting element 18 and the second jib connecting element 19, both jib connecting elements 18, 19 are disposed to each other with a maximum lateral offset which is identical to the lateral offset D of the hinge axis 34, 35 as indicated in FIG. 6. It is possible to provided further pivoting of the first jib connecting element 18 and/or the second jib connecting element 19 concerning the hinge elements 33 such that the lower first booms 36 and the lower second booms 40 are arranged closer to each other and in particular are in contact with each other. As is illustrated in FIG. 9, it is possible to pivot the first jib connecting element 18 to the left, wherein the parallel orientation of the first jib connecting element 18 to the second jib connecting element 19 is maintained. It is also possible to pivot the first jib connecting element 18 to the right and also maintain the parallel orientation of the jib connecting elements 18, 19 with respect to each other. Maintaining the parallel orientation of the jib connecting elements 18, 19 means that the corresponding facing sides of the jib connecting elements 18, 19 at which the jib connecting elements 18, 19 are connected in the operation arrangement are oriented parallel to each other. However, the facing sides of the jib connecting elements 18, 19 may be arranged in different vertical planes having a lateral offset concerning the longitudinal axis 25 which is perpendicular to each of the vertical planes. A margin of an offset in a direction parallel to the longitudinal axis 25 is approximately two times the lateral offset D. As indicated in FIG. 9, the jib connecting elements 18, 19 are arranged with respect to each other such that the hinge element 33 is oriented perpendicular to the longitudinal axis 25. It is possible to maintain, for instance, the first jib connecting element 18 in the position shown in FIG. 9 and to rotate the second jib connecting element 19 together with the hinge element 33 around the first hinge axis 34, wherein the main orientation of the second jib connecting element 19, which is parallel to the first jib connecting element 18, is maintained. Such rotation is possible until the second jib connecting element 19 with the lower second boom 40, i.e., the upper one in FIG. 9, is in direct contact with the lower first boom 36 of the first jib connecting element 18, i.e., the lower one in FIG. 9.

It is also possible to pivot the second jib connecting element 19 together with the hinge element 33 around the first jib connecting axis 34 counterclockwise until the lower booms 36, 40 contact each other.

Obviously, it is also possible to maintain the second jib connecting element 19 in position and to provide a rotation of the first jib connecting element 18 together with the hinge element 33 around the second hinge axis 35. A lateral difference, i.e., the margin of the offset in the direction parallel to the longitudinal axis 25 of the vertical plane in both arrangements as already explained above is approximately two times the lateral offset D.

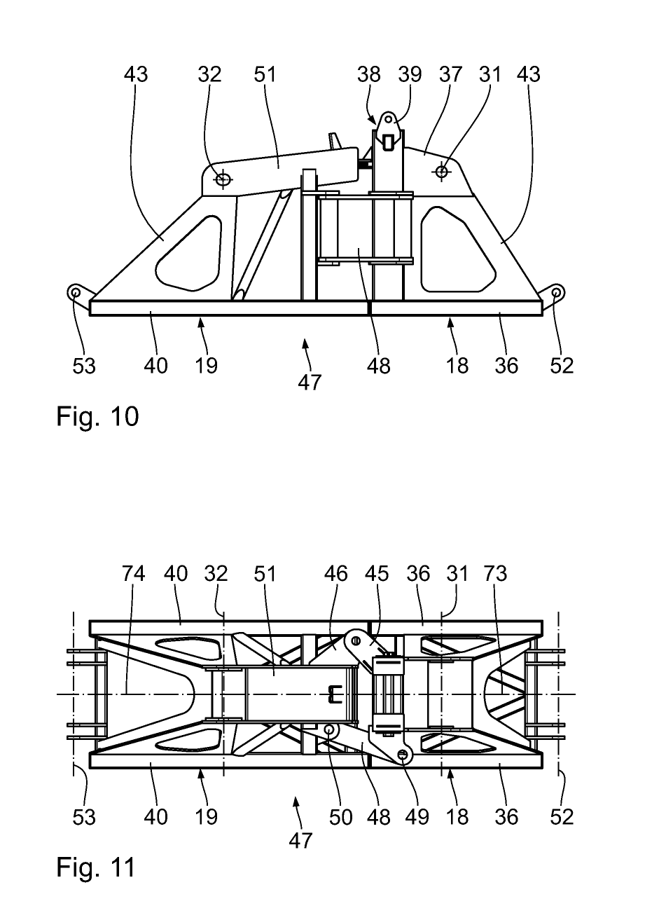

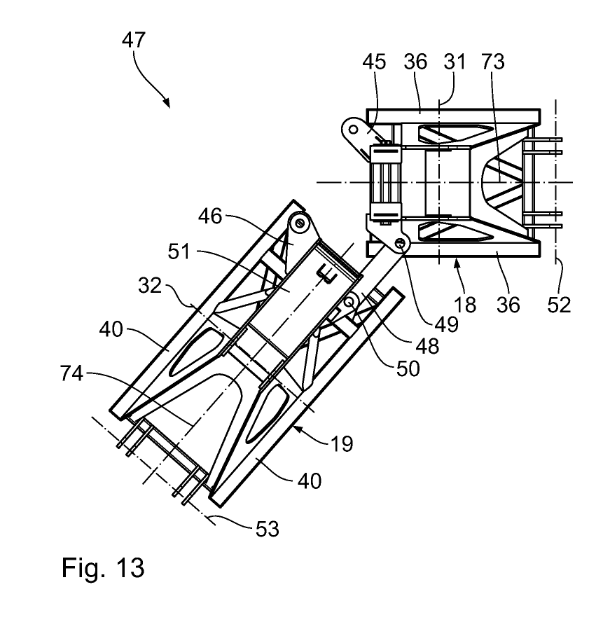

FIGS. 10 to 15 show an exemplary embodiment of a further configuration of a jib connecting unit 47. Components, which correspond to those, which have already been described above with reference to FIGS. 1 to 9, have the same reference numerals and will not be described again in detail.

The jib connecting unit 47 differs from the jib connecting unit 17 essentially in that only one hinge element 48 is provided. The hinge element 48 is provided as a connecting rod, but having an enlarged height along a first hinge axis 49 compared to the connecting rods 33. Thus, the single piece hinge element 48 has an enhanced stiffness concerning the two separate hinge elements 33 of the first embodiment.

Further, the hinge element 48 is integrated in the jib connecting unit 47 such that the first hinge axis 49 and the second hinge axis 50 intersect not only the lower booms 36, 40 of the corresponding lower boom plane sections, but an intermediate section arranged between two parallel corresponding booms 36 and 40, respectively.

A further difference concerning the first embodiment of the jib connecting unit 17 is the upper second plate element 51 which clearly comprises an inclination with respect to a horizontal plane.

In addition, the first jib connecting axis 52 and the second jib connecting axis 53 are provided with a height-offset concerning the lower booms 36, 40. However, the jib connecting axis 52, 53 are arranged in the region of the lower boom plane sections.

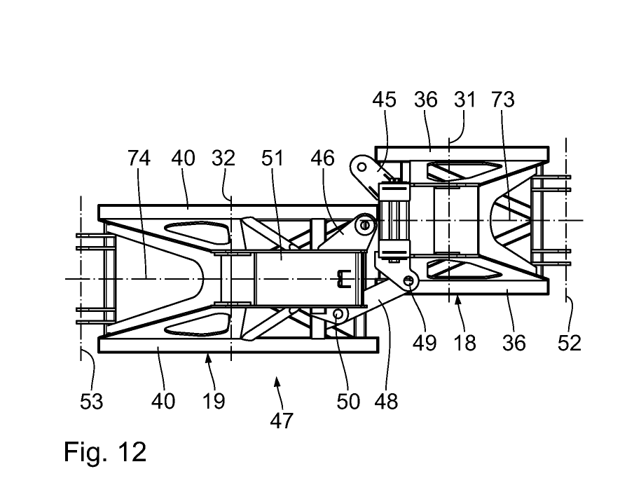

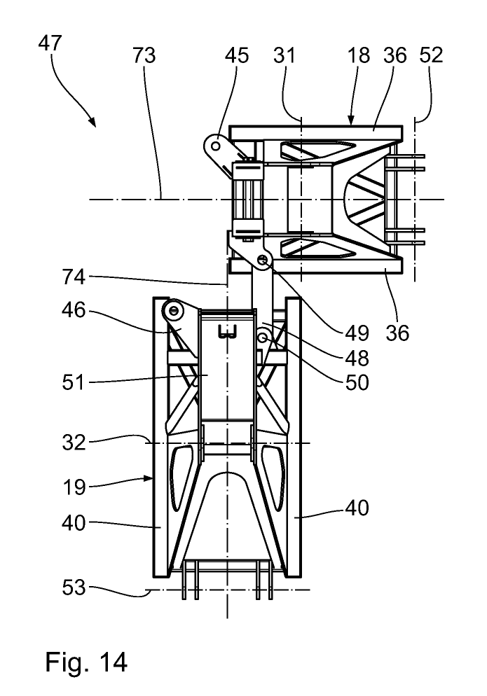

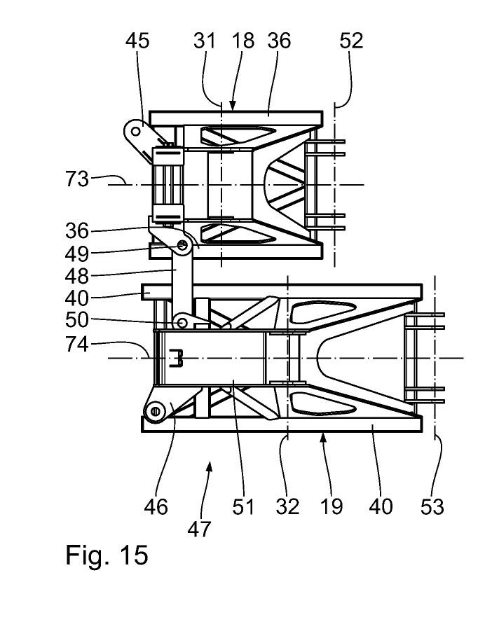

In the following, the second folding step, i.e., the folding of the jib connecting unit 47 is described with respect to FIGS. 11 to 15. Starting from the fixed arrangement in the operation arrangement in FIG. 11, the fixation of the first fixing element 45 and the second fixing element 46 is released. As illustrated in FIG. 12, it is possible to provide a transversal offset of the first and the second jib connecting elements. That means that both jib connecting elements 18, 19 are arranged along the longitudinal axis 25 but not coaxially with respect to the axis 25. The operation arrangement is achieved by pivoting the hinge element 48 counterclockwise around the second hinge axis 50. In a next transformation step, the hinge element 48 is pivoted around the first hinge axis 49 on the one hand and also around the second hinge axis 50 on the other hand. After that, the second jib connecting element 19 is pivoted together with the hinge element 48 around the first hinge axis 49 in a 90° position (FIG. 14). In a last transformation step, the second jib connecting element 19 is pivoted around the second hinge axis 50 only in a parallel arrangement of the both jib connecting elements (FIG. 15). As previously explained concerning the first embodiment of the jib connecting unit of the invention, also the second embodiment provides an offset of the jib connecting elements relative to each other. However, the amount of the offset is reduced, since the hinge axis 49, 50 are provided deeper inside the corresponding cross sectional areas.

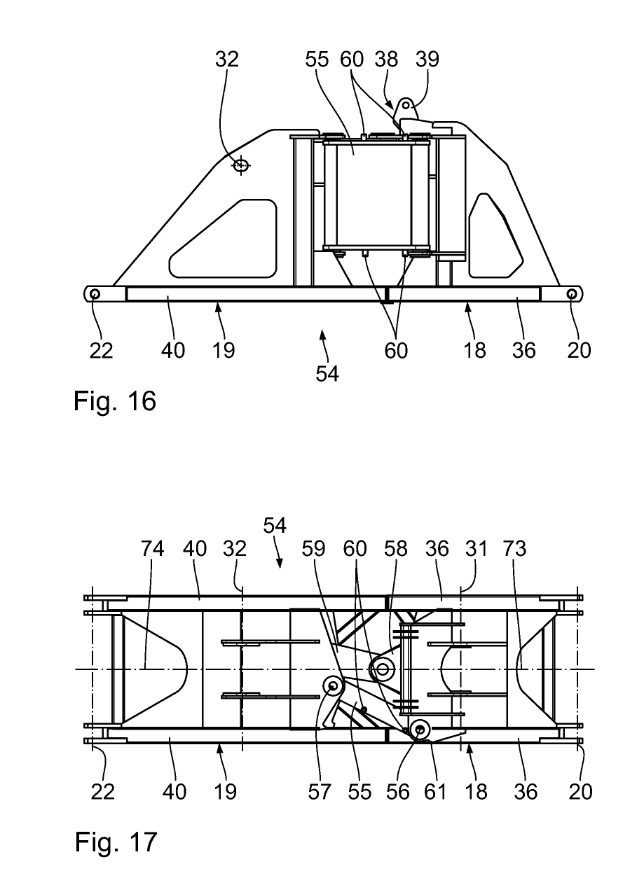

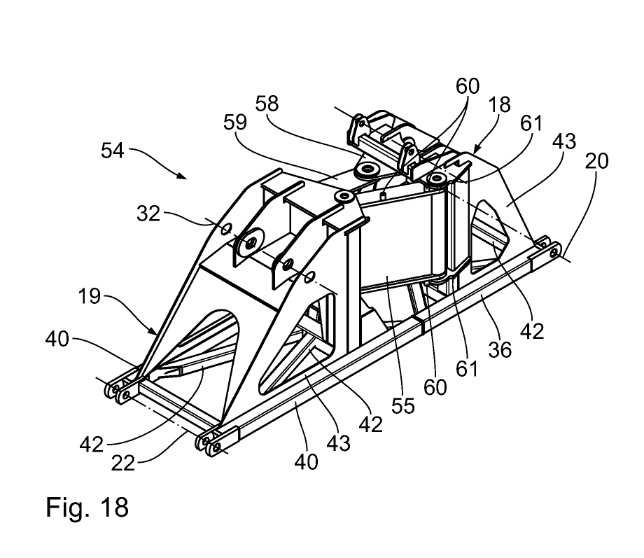

FIGS. 16 to 20 show an exemplary embodiment of a further configuration of a jib connecting unit 47. Components, which correspond to those, which have already been described above with reference to FIGS. 1 to 15 have the same reference numerals and will not be described again in detail.

A jib connecting unit 54 according to a further embodiment of the invention comprises one single hinge element 55. The hinge element 55 is attached to the first connecting element 18 and the second jib connecting element 19 such that the first hinge axis 56 and the second hinge axis 57 are provided inside the corresponding lower boom plane sections, respectively. The fixing axis at which the first fixing element 58 and the second fixing element 59 articulated with each other is disposed in an intermediate plane of the jib connecting element 54. The intermediate plane is vertically oriented and contains the longitudinal axis 25 of the jib 10. The main difference of the jib connecting element 54 regarding previously described embodiments is the hinge element 55. Two positioning pins 60 vertically extend from a lower horizontally extending plate of the hinge element 55. The positioning pins 60 are of importance for the transformation procedure as described in the following.

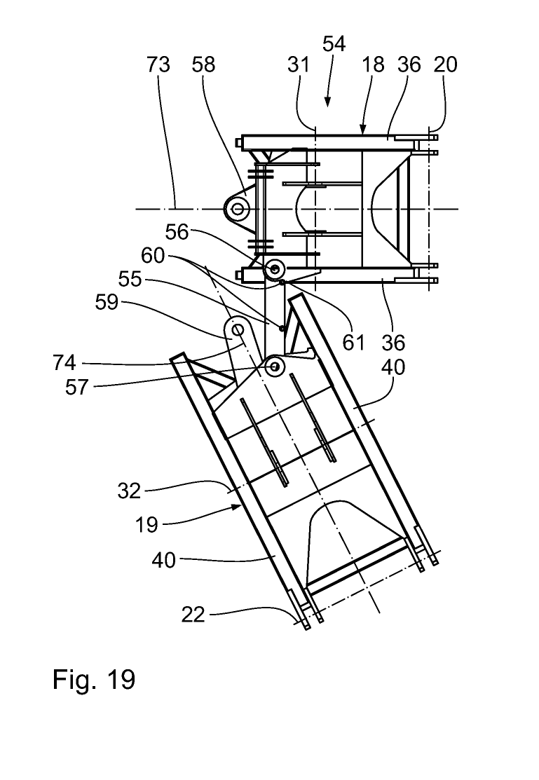

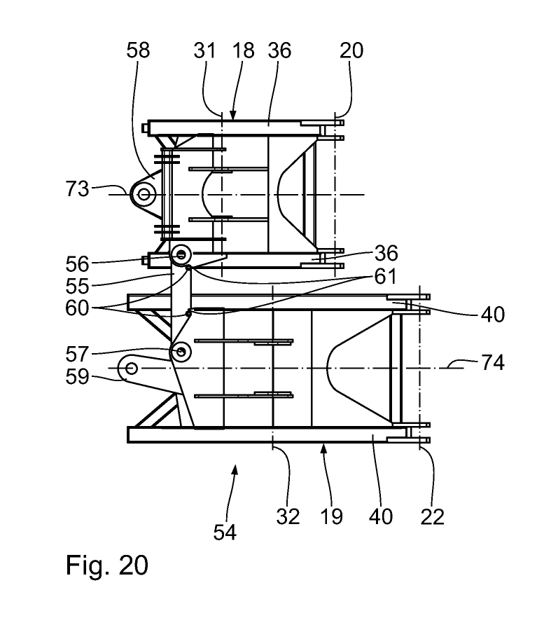

Starting from the operation arrangement of the jib connecting element 54 in FIG. 17, the second jib connecting element 19 is articulated with the hinge element 55 around the first hinge axis 56 into the arrangement as shown in FIG. 19. An articulation around the first hinge axis 56 is automatically stopped when one of the positioning pins 60 reaches a corresponding recess 61 of the first jib connecting element 18. Thus, further articulation of the hinge element 55 around the first hinge axis 56 counterclockwise is prevented. For further transformation of the jib connecting unit 54, then the second jib connecting element 19 is articulated around the second hinge axis 57 into a position of the transportation arrangement shown in FIG. 20. The transportation arrangement is reached when the second positioning pin 60 is disposed in a second recess 61 of the second jib connecting element 19. Thus, the transportation arrangement of FIG. 20 is secured by the position pins 60 each arranged in a corresponding recess 61. However, it is possible to articulate the second jib connecting element 19 together with the hinge element 55 around the first hinge axis 56 clockwise or to articulate the first jib connecting element 18 together with the hinge element 55 around the second hinge axis 57 counterclockwise, such that the first jib connecting element 18 and the second jib connecting element 19 are arranged side by side with contact between the lower booms 36 and 40.

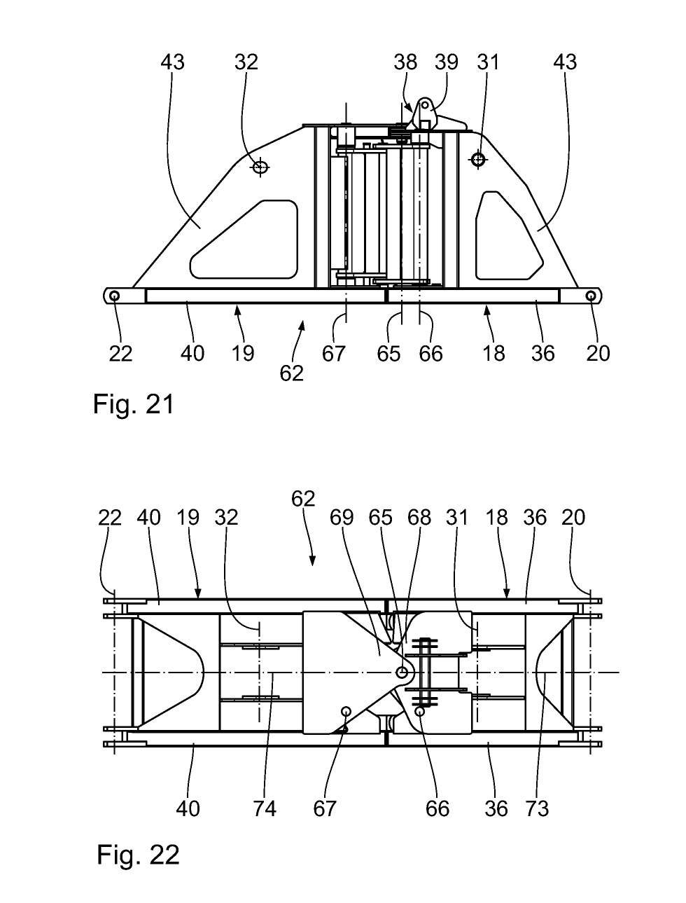

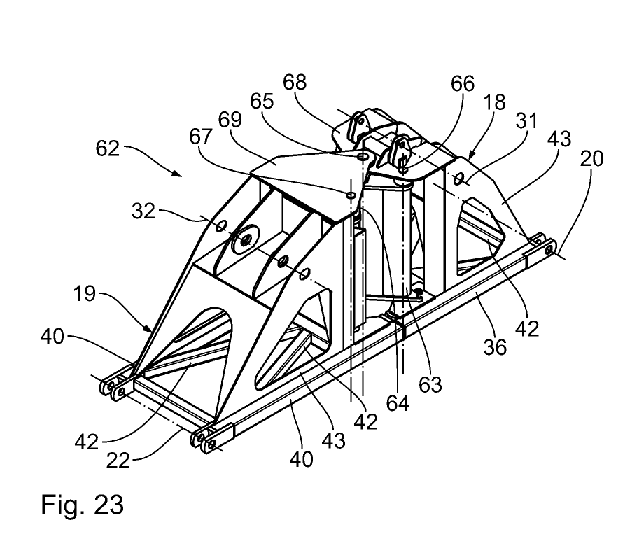

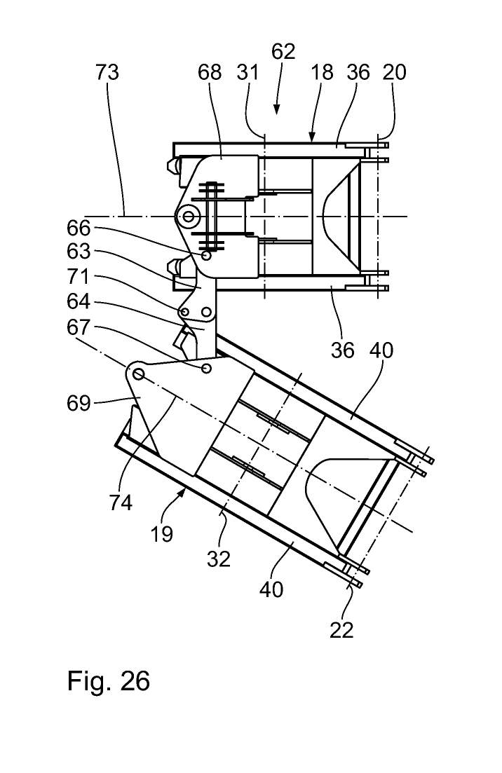

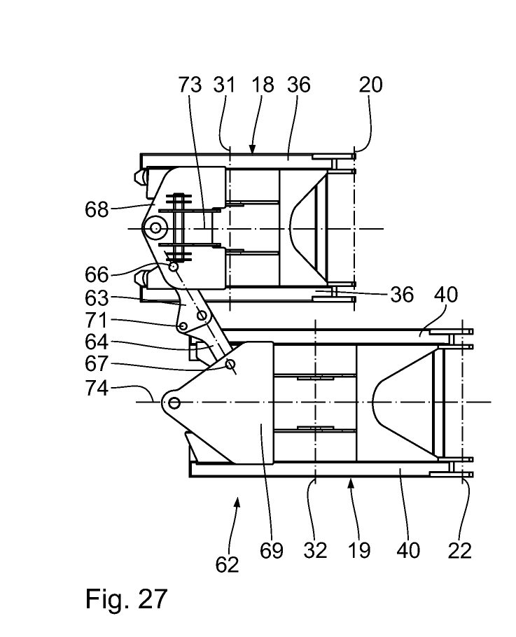

FIGS. 21 to 27 show an exemplary embodiment of a further configuration of a jib connecting unit 47. Components, which correspond to those that have already been described above with reference to FIGS. 1 to 20 have the same reference numerals and will not be described again in detail.

The main difference of the jib connecting unit 62 concerning previously described embodiments is the feature that a first hinge element 63 and a second hinge element 64 are provided, wherein the two hinge elements 63, 64 are articulated at an intermediate hinge axis 65. That means the first hinge element 63 is articulated at the first hinge axis 66 with the first jib connecting element 18. The second hinge element 64 is articulated at the second hinge axis 67 with the second jib connecting element 19. Both hinge elements 63, 64 are pivotally connected with each other around the intermediate hinge axis 65. In the operation arrangement of the jib connecting unit 62 as illustrated in FIGS. 21 to 23, the intermediate hinge axis 65 is coaxially arranged with respect to a fixing axis at which the first fixing element 68 of the first jib connecting element 18 and the second fixing element 69 of the second jib connecting element 19 are fixed with each other. Thus, the operation arrangement of the jib connecting unit 62 is also a connecting arrangement in which the first jib connecting element 18 and the second jib connecting element 19 are directly connected to each other. By releasing the fixation of the first fixing element 68 with the second fixing element 69, it is possible to provide relative displacement of the first jib connecting element 18 and the second jib connecting element 19 with respect to each other.

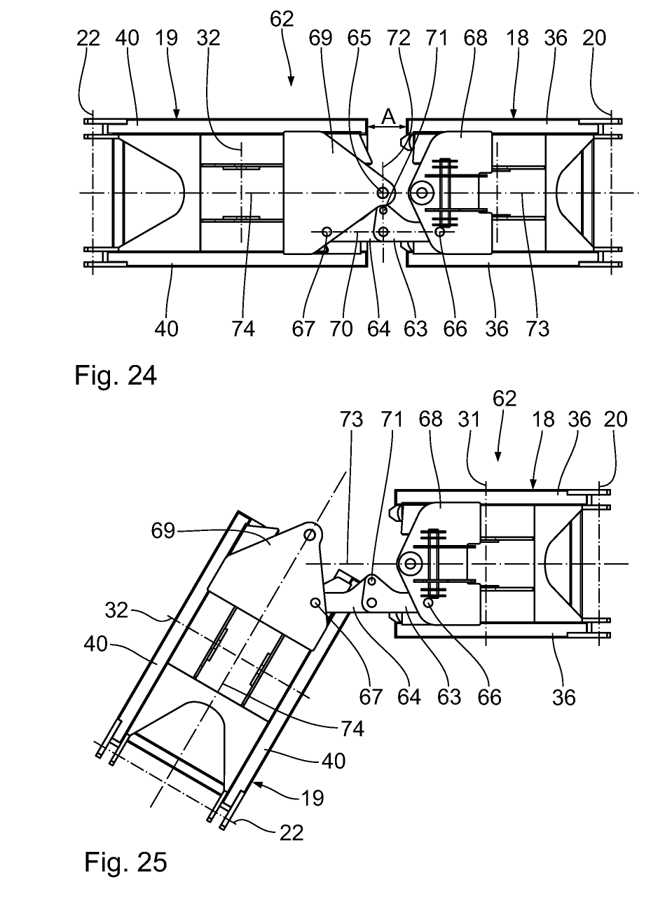

An articulation of the first and the second hinge elements 63, 64 enables an offset arrangement of the jib connecting unit 62 as illustrated in FIG. 24. The offset arrangement provides an axial offset A. the offset is oriented along the longitudinal axis 25.

The offset arrangement is reached when the first hinge axis 66, the second hinge axis 67 and the intermediate hinge axis 65 are disposed on straight line 70. The virtual line 70 is parallel to the longitudinal axis 25. In this offset arrangement, blocking bores 71, which are provided in both the first hinge element 63 and the second hinge element 64, are coaxially aligned. It is possible to connect the first hinge element 63 and the second hinge element 64 with a non-shown connecting element, such as a bolt. Thus, the first hinge element 63 and the second hinge element 64 are connected with each other at the intermediate hinge axis 65 and at the blocking bores 71. Thus, an articulation of the first hinge element 63 with respect to the second hinge element 64 is no longer enabled when using the connecting element in the blocking bores 71. The first hinge element 63 and the second hinge element 64 together build a common hinge element 63, 64, which comprises enhanced stiffness with respect the first hinge element 63 and the second hinge element 64 articulated at the intermediate hinge axis 65.

In the offset arrangement as illustrated in FIG. 24, the intermediate hinge axis 65, the blocking bores 71 and the second fixing element 69 are arranged on a line 72, which is essentially perpendicular to the line 70 and the longitudinal axis 25. However, it is not necessary to provide such aligned arrangement.

After transformation of the jib connecting unit 62 from the operation arrangement in FIGS. 21 to 23 to the offset arrangement as illustrated in FIG. 24, a further transformation of the jib connecting unit 62 is enabled using the blocked common hinge element 63, 64. Starting from the offset arrangement in FIG. 24, the second jib connecting element 19 is articulated at the second hinge axis 67 in a counterclockwise direction. After that, the second jib connecting element 19 together with the common hinge element 63, 64, is articulated at the first hinge axis 66 counterclockwise relative to the first jib connecting element 18. In a last step, the second jib connecting element 19 is articulated at the second hinge axis 67 in the counterclockwise direction such that the first jib connecting element 18 and the second jib connecting element 19 are oriented parallel to one another, i.e., such that the lower booms 36 and 40 are oriented parallel to one another. As illustrated in FIG. 27, it is possible to arrange the common hinge element 63, 64 in a position such that the line 70 is not perpendicular to the longitudinal axis 25.

What is claimed is:

1. A jib for a crane comprising:
a first jib element,
a second jib element connected to said first jib element, and
a jib connecting unit, connecting said first jib element to said second jib element,
said jib connecting unit comprising:
a first jib connecting element being articulated to said first jib element,
a second jib connecting element being articulated to said second jib element,
a first hinge element being articulated to said first jib connecting element,
a second hinge element being articulated to said second jib connecting element,
wherein said jib is configured to be foldable between an operation arrangement and a transportation arrangement,
wherein said operation arrangement configures said first jib element and said second jib element to be coaxially arranged in a longitudinal direction of said jib,
wherein under said transportation arrangement said jib is folded such that said first jib element axis and said second jib element axis are arranged parallel with respect to each another,
wherein a first hinge axis is transversally oriented with respect to a first jib connecting axis, and
wherein a second hinge axis is transversally oriented with respect to a second jib connecting axis.

2. The jib according to claim 1, wherein said first jib connecting element and said second jib connecting element are configured in a trapezoid shape.

3. The jib according to claim 2, wherein said first jib connecting element comprises a lower first boom configured in a lower first boom plane section, and said first hinge axis intersects said lower first boom plane section.

4. The jib according to claim 3, wherein said first jib connecting element comprises an upper first boom plane section, configured at least partially by an inclination with respect to a horizontal plane.

5. The jib according to claim 4, wherein said first jib connecting element is connected to said first jib element by a first telescopic cylinder, said first telescopic cylinder is articulated at a first cylinder hinge axis against said first jib connecting element, and said first cylinder hinge axis is configured between said lower first boom plane section and said upper first boom plane section.

6. The jib according to claim 5, wherein said second jib connecting element comprises two lower second booms configured in a lower second boom plane section, and a second hinge axis intersects said lower second boom plane section.

7. The jib according to claim 6, wherein said second jib connecting element comprises an upper second boom plane section, configured at least partially by an inclination with respect to a horizontal plane.

8. The jib according to claim 7, wherein said second jib connecting element is connected to said second jib element by a second telescopic cylinder, configured to be articulated at a second cylinder hinge axis against said second jib connecting element, and said second cylinder hinge axis is configured between said lower second boom plane section and said upper second boom plane section.

9. The jib according to claim 8, wherein two hinge elements are configured to be concentric with respect to said first hinge axis and said sec- and hinge axis.

10. The jib according to claim 9, wherein said two hinge elements are spaced apart from one another alongside said first hinge axis and said second hinge axis.

11. The jib according to claim 1, wherein two hinge elements are articulated at an intermediate hinge axis.

12. The jib according to claim 11, wherein said two hinge elements are configured to be displaceable between a connecting arrangement and an offset arrangement, wherein in said connecting arrangement, said first jib connecting element and said second jib connecting element are connected to another, and wherein in said offset arrangement, said first jib connecting element and said second jib connecting element are spaced apart from one another alongside a longitudinal axis by an axial offset.

13. The jib according to claim 12, wherein an intermediate hinge axis is configured to be coaxial to a fixing axis, and said first jib connecting element and said second jib connecting element are fixed to one another in an operation mode.

14. The jib according to claim 13, wherein each of said two hinge elements comprises a blocking bore, wherein in said offset arrangement, said blocking bores are aligned coaxial and are connected by a connecting element, and articulation around said intermediate hinge axis is prohibited.

15. The jib according to claim 14, wherein said first jib connecting element and said second jib connecting element comprise a fixing element configured to be fixed to one another in said operation arrangement of said jib.

16. A crane, comprising:
a basic structure,
a mast comprising a mast longitudinal axis,
wherein said mast is connected to said basic structure,
a jib according to claim 1,
wherein in said operation arrangement, the first jib element and the second jib element are configured to be coaxial to a longitudinal axis, and
wherein under said transportation arrangement one of said first and second jib elements is configured such that said longitudinal axis and a first jib element axis and a second jib element axis are arranged at corners of a triangle.

17. A self-erecting crane with a foldable jib, comprising:
a first jib element,
a second jib element,
a third jib element, and
a jib connecting unit connecting said first jib element to said second jib element,
wherein said second jib element and said third jib element of said foldable jib are configured alongside a mast of said self-erecting crane in a transportation position,
wherein said jib connecting unit further comprises:
a) a first jib connecting element having a rectangular base, wherein said first jib connecting element is connected to the first jib element in the area of lower booms at a transverse first jib connecting axis and said first jib connecting element is connected to the first jib element via a first telescopic cylinder to upper booms of the first jib element,
b) a second jib connecting element having a rectangular base, wherein said second jib connecting element is connected to the second jib element in the area of lower booms at a transverse second jib connecting axis and said second jib connecting element is connected to the second jib element via a second telescopic cylinder to upper booms of the second jib element,
c) a hinge element joining the first jib connecting element to the second jib connecting element, wherein the hinge element determines at least one vertical hinge axis, and
d) a non-permanent fixing element for interlocking the jib connecting element with the second jib connecting element in an operation position of the crane,
wherein the at least one hinge axis is situated at least partially inside the jib connecting unit.

18. The self-erecting crane according to claim 17, wherein two hinge elements being articulated at an intermediate hinge axis are provided.

19. The self-erecting crane according to claim 18, wherein the two hinge elements are displaceable between a connecting arrangement and an offset arrangement, wherein in the connecting arrangement the first jib connecting element and the second jib connecting element are directly connected to each other, and wherein in the offset arrangement the first jib connecting element and the second jib connecting element are spaced apart from each other along the longitudinal axis with an axial offset.

20. The self-erecting crane according to claim 19, wherein the intermediate hinge axis is coaxially arranged to a fixing axis at which the first jib connecting element and the second jib connecting element are fixed with each other.

21. The self-erecting crane according to claim 19, wherein each of the two hinge elements comprises a blocking bore, wherein in the offset arrangement said blocking bores are aligned coaxially and are connected by a connecting element such that articulation around the intermediate hinge axis is prevented.

22. The self-erecting crane according to claim 17, wherein the first jib connecting element and the second jib connecting element each provide at least one fixing means to be fixed to each other.

23. The self-erecting crane according to claim 19, wherein a first hinge element is articulated at a first hinge axis with the first jib connecting element and a second hinge element is articulated at a second hinge axis with the second jib connecting element, wherein in the offset arrangement the first hinge axis, the second hinge axis and the intermediate hinge axis are disposed on a straight line.

24. The self-erecting crane according to claim 23, wherein the line is parallel to a longitudinal axis of the jib.

25. The self-erecting crane according to claim 17, wherein the at least one hinge axis intersects a lower boom plane section of the first jib connecting element or of the second jib connecting element.

26. The self-erecting crane according to claim 25, wherein the lower boom plane section builds a rectangular base having lower booms, wherein the at least one hinge axis intersects at least one of the lower booms.

27. The self-erecting crane according to claim 17, wherein the at least one hinge axis is situated completely inside the jib connecting unit.

28. The self-erecting crane according to one of claim 17, wherein the at least one hinge axis intersects a rectangular base built by a lower boom plane section and a rectangular roof built by an upper boom plane section.
